(19) United States
(12) Patent Application Publication
(10) Pub. No.: US 2013/0283141 A1
(43) Pub. Date: Oct. 24, 2013

(54) Client Agnostic Spatial Workflow Form Definition and Rendering

(71) Applicants: David Stevenson, Victoria (CA); Christian Morin, Victoria (CA); Ryan Cooney, Victoria (CA)

(72) Inventors: David Stevenson, Victoria (CA); Christian Morin, Victoria (CA); Ryan Cooney, Victoria (CA)

(73) Assignee: Latitude Geographics Group Ltd., Victoria (CA)

(21) Appl. No.: 13/452,530

(22) Filed: Apr. 20, 2012

(51) Int. Cl. G06F 17/00; G06F 15/16

(52) U.S. Cl. 715/222

(57) ABSTRACT

A method for building client agnostic, discoverable service oriented workflow forms for collecting spatial data input composed of spatial features and metadata is described that permits a workflow engine to export a user-defined spatial workflow represented as a service and described as XML. This workflow is composed of numerous spatial and non-spatial workflow activities chained together and includes forms for collecting user input. These forms are described using XML and can be rendered on clients irrespective of their user interface technology.

### TECHNICAL FIELD OF THE INVENTION

This method relates to the design and use of user interface forms in a larger spatial workflow for collecting spatial data in the form of spatial features (points, lines, polygons) and associated attributes (metadata) in a client-server environment of mixed platforms.

### BACKGROUND OF THE INVENTION

In Client-Server systems, typified by proprietary or open standards based communication, there is communication that occurs between endpoints to transfer data, update state, capture input, perform processing and other functions of each respective endpoint.

This series of steps that involve processing on the client or server and the intercommunication of said processing can be described as a workflow. In most situations, the client or “user” of the system initiates a workflow, but is also possible for a server system to act as a client as well.

Workflows are designed to mimic or capture a process that exists in the real world. Spatial workflows are real world processes that make use of spatial data, map display or other geographic reference data and may include spatial processing.

In a GIS (Geographical Information System) or spatial system, spatial features are the building blocks for the display and processing of spatial information. A spatial feature is a geometric representation of its shape in some coordinate space, and is referred to as its geometry. Spatial features can be described as one of three shapes: a point, line or polygon. An example of a point feature in a spatial system may be a tree or a mailbox or a gas well. An example of a line feature may be railroad tracks, a highway or a sewer line. An example of a polygon feature may be a building footprint, a zip code boundary or the outline of a country. Spatial features may also have metadata, referred to as attributes. Attributes describe properties of the spatial feature. For example, with a tree point feature, its associated attributes may be the tree species, its height and the date it was planted.

Workflows may involve processes and interfaces that can be run self-contained, within a single monolithic environment, or require additional data or processing that require communication with an external system, database or server.

Workflows are composed of a series of steps, or activities that describe a package of work. An activity may be to geocode an address or buffer a point. A very common workflow activity is to capture spatial data input from a user interacting with a user interface form.

The state of the art within workflow processing for spatial data systems (GIS) incorporates an architecture whereby large spatial datasets and corresponding geoprocessing reside within centralized, server based systems. This is due to the fact that these spatial datasets are large (multi-terabyte) and require significant processing and memory resources in order to perform analysis and querying. As a result, we typically observe thin desktop, web and mobile clients making use of centralized server(s) to retrieve and display geographic information and perform needed processing. Limitations of network speed, local storage and processing capability restrict the ability to perform these operations to centralized server systems.

A typical workflow would be initiated by a user, interacting with a (thin) client application. They would click a button, swipe a screen or input a voice command in an application they're running in their respective environment and platform (the “Client”) to initiate the workflow. As part of the workflow they've initiated, they may require resources, processing or data that exist on a separate system or platform, physically and logically independent of the Client. This separate system is the “Server”. This request is packaged into a message, sent across a communication medium and is received by the Server. The Server decodes the message, initiates the workflow locally, and processes the request for spatial data, spatial processing or resources. When the workflow arrives at an activity that involves interaction, processing or input from the Client, it packages the request into a message and sends this request back to the Client. The Client receives the message, decodes it and performs the corresponding action in the message. This sequence continues until the end of the Workflow definition.

An example of such a real world workflow would be where a user would like to summarize, in a PDF formatted report, all of the parcels within a radius of 1 mile from a user defined point on a map OR from within 1 mile of the current location of the client platform (tablet computer) that have a land value greater than $100,000. In this example we assume the user has started his/her client application, and that it is in communication with a server housing the corresponding workflow definition, underlying geodata and any geoprocessing services required to perform said workflow. This workflow would begin by the user clicking a button or selecting a drop down item to initiate the workflow. A (modal) workflow form would appear that would prompt the user to enter a point (defined by latitude and longitude values) by either clicking on a corresponding map within the client application, by entering values for latitude and longitude into corresponding text fields in the form or by querying the on board GPS device. The client application would collect this point information and send it to the server to initiate server side processing of the workflow. The client would then wait or block for a response from the server. The server side workflow would then perform a buffer operation to determine all of the parcels that spatially intersect the 1 mile radius, and would then perform an attribute query on said selected set to further refine results for a land value greater than $100,000. Workflow processing on the server would cease, and this selected set of parcels would be sent to the client application for highlighted display, along with the buffer radius depicted the extent of the area within a message, including a generic form definition. The user would then be prompted, via form, to further refine results as needed, via additional ad-hoc query on the attribute set represented within the parcel feature type. The user declines this option, selecting instead to output the selected set of parcels to a formatted, PDF report, by pressing a button to generate the report. Client workflow processing ceases, and the selected set is returned to the server where server side workflow processing resumes. The server side workflow takes the selected set of parcels, matches to a pre-defined report template, populates the report and dynamically generates the PDF. The server side workflow then generates another message that contains a hyperlink to the generated report as well as another client-agnostic form definition. Server side workflow processing ends. The message is received by the client application, decoded and the form is read and rendered to the user. The user clicks on the hyperlink to access the generated report, and views it.

The collection of spatial geometry and attribute data via workflow forms differs from general data collection in that a user or a client application may make use of any number of different spatial collection methods in order to generate geometry and attribute data. For example, a user may click on a point on a displayed map or make use of an on-board GPS device in order to denote a point in space.

In the workflow activity case of collecting spatial data input from a user interacting with a Client application, the workflow form is typically designed in advance and hard-coded by a user interface developer, and authored to specifically work on a target client platform. When a Client receives a Workflow message to display said form, the Client decodes said message and, using a reference ID, displays the corresponding, pre-defined form to the user. When the user populates said form with spatial data, the client application returns this input data to the server for further workflow processing, or uses this data for further client side processing. In either case, this input is known in advance.

Workflows are authored and designed using a variety of tools. A workflow may be designed and implemented programmatically, in that the workflow and constituent activities are described using a programming language and compiled to a computer binary. Workflows may also be described and implemented using a command line, file based or graphical user interface tool that permits a workflow designer to build a workflow, have this workflow be represented by an intermediate description file, wherein the underlying workflow engine interprets this description file at workflow run-time.

### OBJECTS AND ADVANTAGES

It is an object of the invention to provide a system and method for spatial application developers to accelerate productivity and flexibility by building and maintaining spatial workflow forms using this invention.

It is a further object of the invention to provide a system and method for application developers to maintain spatial workflow forms irrespective of changes in technology.

It is a further object of the invention to provide a system and method for a graphical user interface tool to design and build spatial workflow forms.

It is a further object of the invention to provide a system and method for a graphical user interface tool to express designed spatial workflow forms using eXtensible Markup Language (XML).

It is a further object of the invention to provide a system and method to allow users to build a library of spatial workflow forms.

It is a further object of the invention to provide a system and method to permit the re-use of a library of spatial workflow forms.

It is a further object of the invention to provide a system and method to expose described spatial workflow forms as a webservice, via SOAP or REST endpoint.

It is a further object of the invention to provide a system and method to make spatial workflow forms discoverable.

It is a further object of the invention to provide a system and method to describe spatial workflow forms in a technology independent way.

It is a further object of the invention to provide a system and method for multiple client platform and application technology types to be served with the same, common technology agnostic spatial workflow form definition.

It is a further object of the invention to provide a system and method for a common form rendering approach to be architected from client application to client application.

### SUMMARY OF THE INVENTION

In accordance with aspects of the present invention, a method and apparatus for authoring, using and rendering spatial workflow forms is provided.

Spatial workflow forms are authored using a graphical user interface (GUI) workflow designer tool that allows the user to layout said forms for client application rendering, display to the user and data collection.

The spatial workflow form is represented as eXtensible Markup Language (XML), and includes any combination of spatial data input field, as defined by the user.

The spatial workflow and accompanying spatial workflow form is exported as a webservice via webserver.

Any number of client applications and platforms can discover and access this webservice.

A client application initiates a spatial workflow, and during the course of the workflow, is prompted to display a technology agnostic, spatial workflow form. The client application renders said form for display to the user.

The user can, making user of any number of geometry and attribute collection mechanisms resident on a given client platform, complete the provided form.

This collected data is returned to the server and workflow processing continues or ends, to support the business spatial process originally architected.

### BRIEF DESCRIPTION OF THE DRAWINGS

FIG. 1. is a flowchart representing a common spatial workflow.

FIG. 2. is the graphical user interface design tool used to author spatial workflows and forms.

FIG. 3. is the graphical user interface form designer tool.

FIG. 4. is the administrative graphical user interface for the application used to export spatial workflows and forms as webservices.

FIG. 5. is a high level conceptual architecture diagram of the major components within a client-server spatial workflow system.

FIG. 6. is a high level conceptual diagram of the communication sequence between client and server in a distributed spatial workflow.

FIG. 7. is a high level conceptual diagram of the internal processing of a spatial workflow form in a client application environment.

FIG. 8. is a high level conceptual diagram of the internal processing of a spatial workflow form in a server environment.

FIG. 9. is the eXtensible Markup Language (XML) file listing of a form definition.

FIG. 10. is a sample Silverlight client web browser interactive mapping application with a spatial workflow form shown within the left data panel (non-modal).

FIG. 11. is a sample HTML5 client web browser interactive mapping application with a modal spatial workflow form rendered for display to the user.

### BEST MODE FOR CARRYING OUT THE INVENTION

Exemplary embodiments of the invention bring together a number of software and business components in order to realize the best mode for implementation.

Actors that interact with an exemplary embodiment of the invention fall into several categories. These are the workflow designer, the workflow developer and the workflow user.

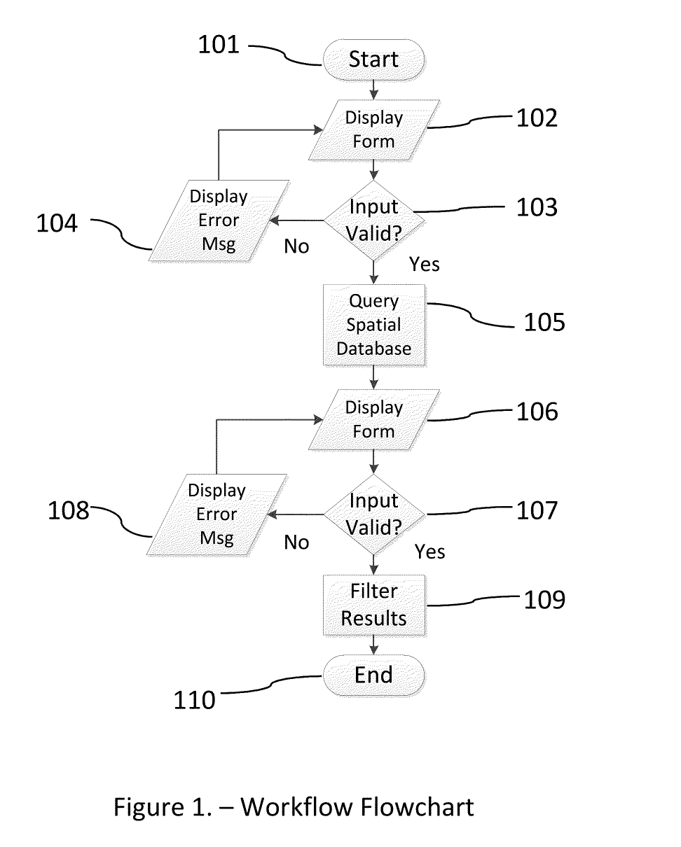

Prior to implementing any software embodiment of the invention, it is the workflow designer's responsibility to design the workflow to closely mimic a real-world, spatial workflow. The designer accomplishes this task by interviewing, researching, observing and documenting one or more spatial workflows. The workflow designer may then elect to document the workflow using a flowchart, as shown in FIG. 1. The purpose of the flowchart is to articulate the spatial workflow in conceptual form to aid implementation, as well as being a mechanism for workflows users to review and validate the workflow designer's assumptions. The workflow described in FIG. 1 is as follows.

The workflow starts 101. A client application displays a user interface form 102 that prompts the user to select natural gas pumping stations by “type”, “volume of gas” and operator. It also prompts the user to click a point on the map, and to specify a buffer distance from within which to select features. The user selects a value of “High pressure” from a drop-down box for the “type” field, enters a string value of “1,000,000” for the “volume of gas” and selects an operator of “>=”. The form validates these entry values 103, and if they're incorrect, displays a modal error alert for 5 seconds 104, and returns the user to the form. If the values are correct, the client application queries 105 a server-housed spatial database to return the set of features that meet the supplied criteria. The result set is displayed to the user in another form 106, and prompted to further filter the results by “Construction date”. The form again validates user input 107, performing a further server-side spatial attribute query 109.

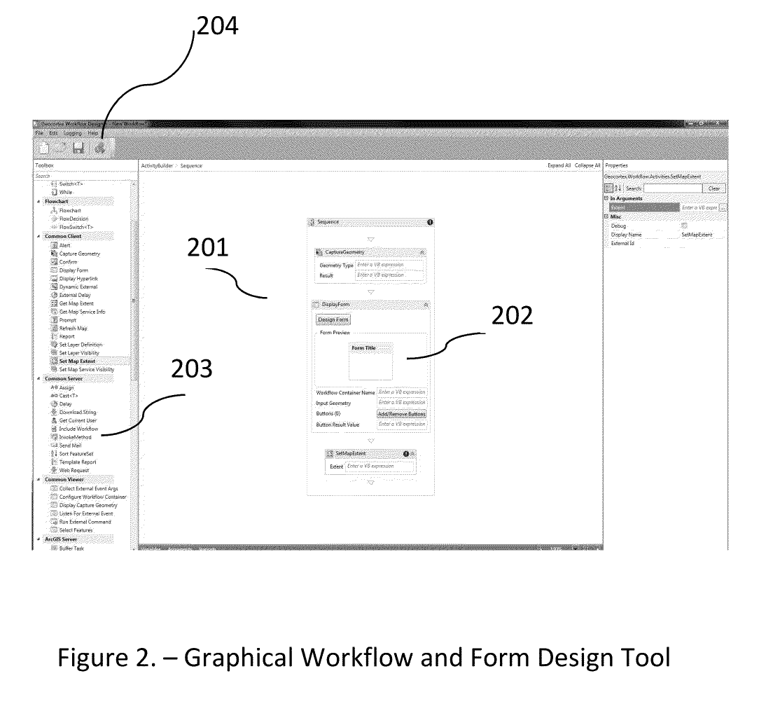

Once a workflow design is complete, the workflow designer translates this to a functional implementation by working with a workflow developer (although these two roles may be played by one individual) and the Workflow Designer graphical user interface tool to implement the design. This tool is shown in FIG. 2.

The Workflow Designer tool is designed to replicate a (physical or conceptual) flowchart that was created by the workflow designer in order to implement a spatial workflow in the form of instructions that can be interpreted by a digital computer.

The workflow designer implements an embodiment of a workflow design by dragging and dropping activities and forms from the activity library 203 onto a workflow canvas 201. An embodiment of a spatial workflow, client technology agnostic form is shown in 202. An exemplary embodiment of a graphical user interface workflow designer tool and workflow engine would make use of Windows Workflow Foundation or other similar workflow foundation technology. As each activity is added to the workflow canvas 201, the workflow developer configures the activities input and output parameter to correspond to the corresponding processing happening at each stage of the workflow. Once the workflow is complete, it can be simulated by making use of a built-in workflow simulator 204.

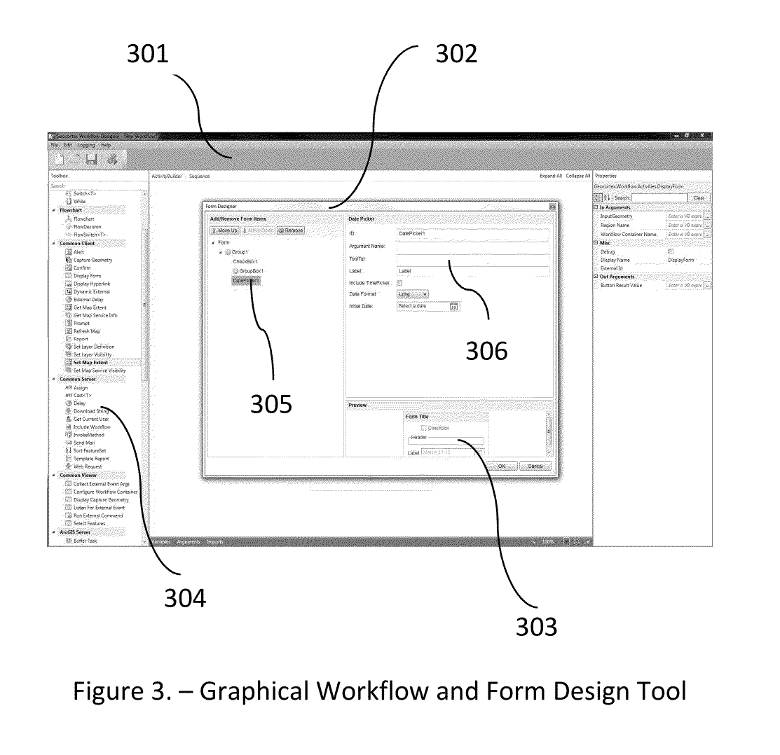

An exemplary embodiment of the invention would make use of a graphical user interface form design tool 302 that is embedded within the overarching workflow design tool 301. This is depicted in FIG. 3. The form design tool 302 can be launched by double clicking on a form activity that has been dragged from the activity library 304 placed in the workflow canvas 201. Form elements like text entry boxes, drop down menus, text and calendar items can be added to the form via the add button 305. Each of these elements is configured via the configuration menu 306. A preview of what the form will look like (shown using a Microsoft Windows styled environment, and not an explicit preview based on the environment in which the form will appear) gives the designer a sense for its user interface 303. When the form and corresponding workflow are saved, the workflow is written to an eXtensible Markup Language (XML) formatted file depicting the workflow and embedded forms.

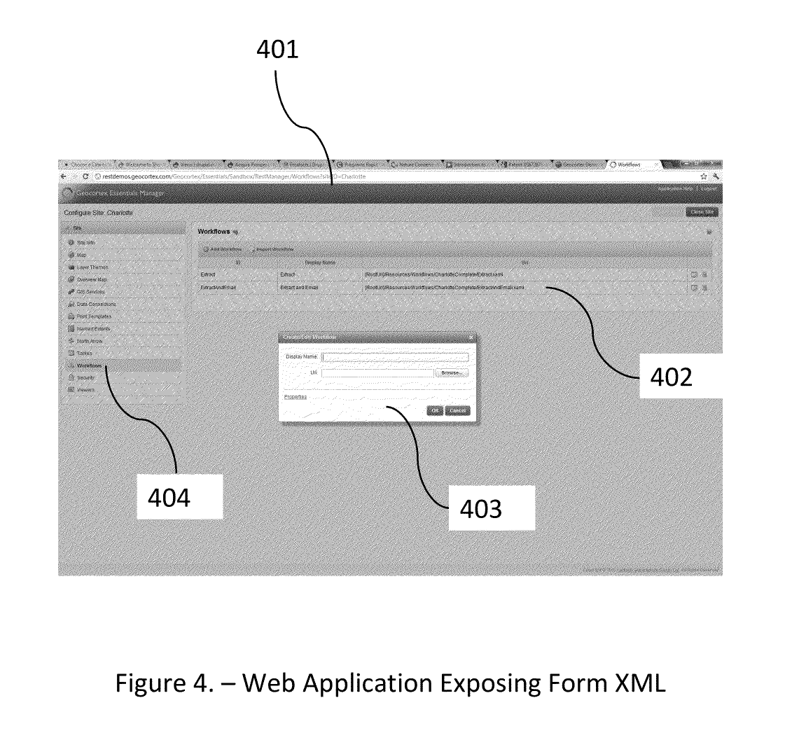

Once the spatial workflow and forms have been designed and saved via the workflow design tool FIG. 2, the workflow needs to be exposed as a webservice for access via client applications and to permit discovery. This is achieved using a web based administrative tool shown in FIG. 4. In the exemplary embodiment of the invention, this is achieved using a Spatial Application Infrastructure (SAI) admin tool. The tool depicted in FIG. 4 is Geocortex Essentials Manager, but any SAI admin tool that supports workflow definition publishing would suffice. The workflow developer would select the “Workflows” tab 404, and would be presented with a list of exported workflows (if any exist) 402. The workflow developer would then add a new workflow service by clicking on the “Add workflow” button, which would present the “Create Workflow” form 403. The workflow developer would browse to the location of the workflow definition eXtensible Markup Language (XML) file, and publish the workflow. Once the workflow was published, it would show up in the exported workflows list 402.

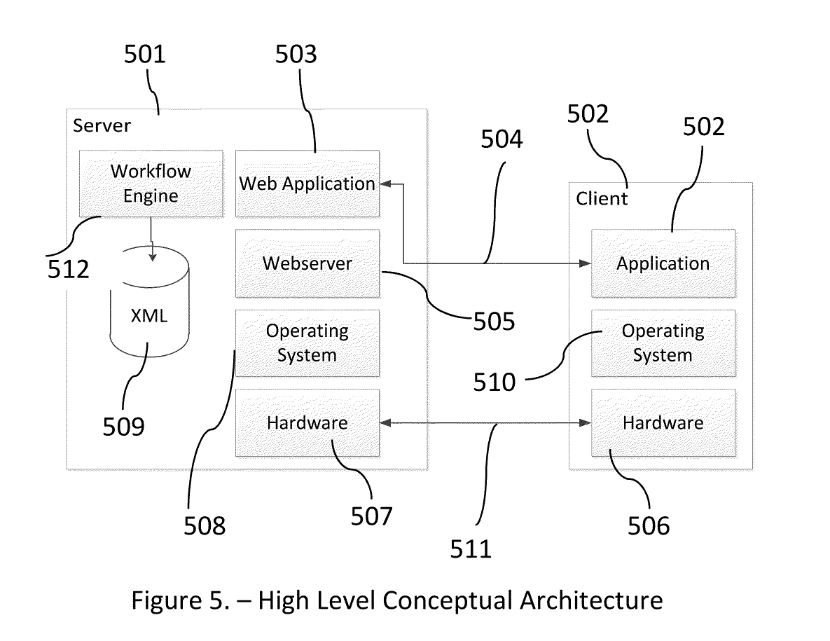

An exemplary embodiment of the invention involves a system of one or more server-based workflow services combined with one or more client applications that consume and interact with these workflow services. This high level architecture is depicted in FIG. 5. These server systems 501 may be resident on one or more virtual or physical server hardware platforms, spread physically across an enterprise and/or an intranet or internet. Such a virtual or physical server is composed of the elements shown in FIG. 5, and include hardware 507, operating system 508, webserver 505, web application 503, workflow engine 512 and stored workflow definition as eXtensible Markup Language (XML) 509. An example of a server system would be a server computer running Windows Server 2003 using a SQL Server database. A client platform 502 and application are also depicted in FIG. 5, and include hardware 506, operating system 510 and application 502. An example of a client platform, capturing the constituent parts above would be an Apple iPad. Note that both the client and server may reside on the same physical or virtual server, but most embodiments of the invention will see server and clients reside on different hardware platforms and be physically separate from each other. 511 shows the bi-directional, logical flow of information between client and server, typically via HTTP network connection over TCP/IP, composed of packets or HTTP commands. 504 shows the conceptual, bi-directional flow of information between client and server, and we can think of this link as being workflow activities and forms.

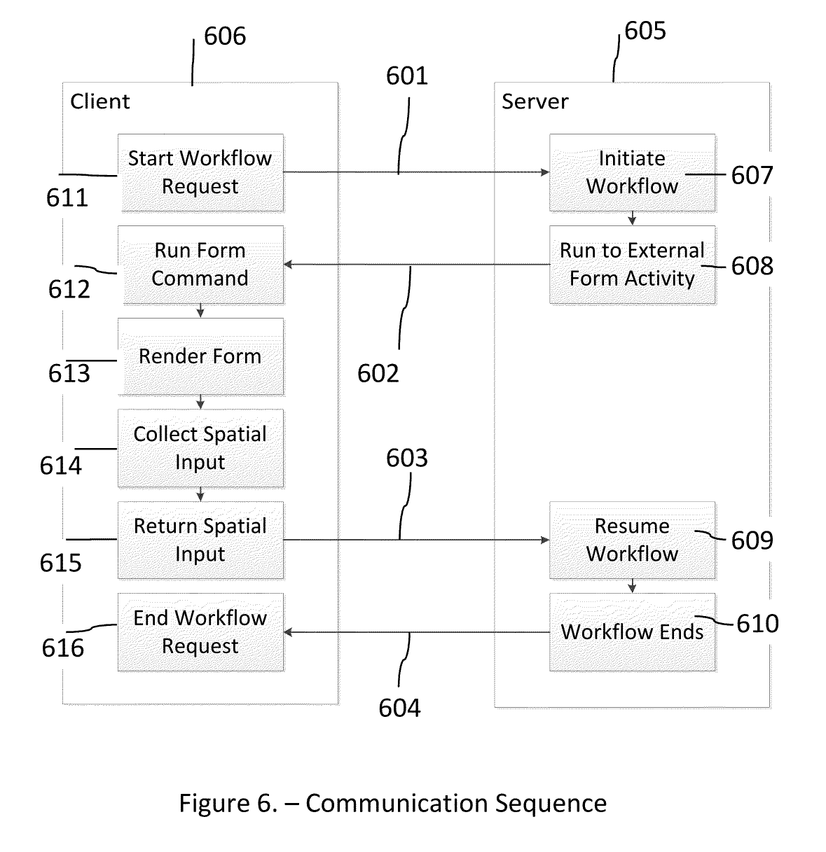

If we extend this conceptual idea of bi-directional communication of workflow activities and forms (and client acknowledgements) this is depicted in FIG. 6. FIG. 6 shows the communication sequence between client 606 and server 605 for sending a technology agnostic spatial form definition message, deciphering the message on the client, rendering the form, collecting user input, and returning the results to the server-side workflow engine. 601 shows a client application initiating a workflow by sending a message to the server. This would typically occur because a workflow user has clicked a button or launched the application to start the workflow 611. The specific workflow webservice chosen by the client tells the server workflow engine which, of several possible workflows, to launch. The server initiates the workflow 607 and may run through a number of workflow activities before it hits an external, form activity 608. At this point, the workflow engine builds a client technology agnostic spatial workflow form definition message and sends it back to the client 606 in 602, and suspends server side workflow processing. The client application receives the message and decodes it. It recognizes the message type as a form definition, runs the form command 612, parses the definition and renders the spatial form 613 for the workflow user to interact with. The user may perform a number of actions associated with the form, in addition to entered form input in the form of text, integers, spatial coordinates, spatial envelopes, slope, etc. as well as capturing spatial geometry using any client specific collection mechanism (click map canvas, GPS, LIDAR, etc.) 614. When the workflow user submits the form by clicking on a button, the client application packages the spatial input data into a message 615 and returns this to the server in 603. The server side workflow engine re-initiates the workflow 609 at the prescribed activity within the workflow, and activity processing continues. Interaction with the client may occur many more times, or the workflow may run to completion. When the workflow completes 610, the server creates a final, workflow complete message and sends this to the client in 604, where its received by the client to end the workflow 616.

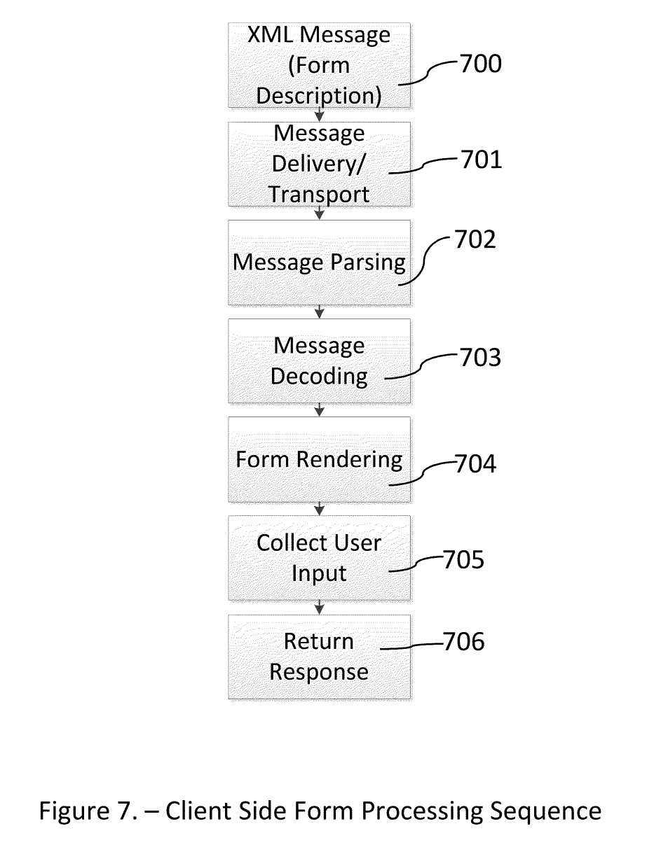

Client application spatial workflow form processing is depicted in FIG. 7. The message is initially built by the server 700, is delivered as JSON, includes a state variable that identifies where the workflow should resume on callback and includes an eXtensible Markup Language (XML) spatial form definition. The message is delivered via HTTP over TCP/IP 701. The client application is notified of message delivery via underlying operating system, web browser or built-in event notification. The client application parses 702 and decodes 703 the message to determine its type. In this example, the client application determines that the message type is a spatial workflow form, and passes the eXtensible Markup Language (XML) form definition to the form renderer 704 to write the form user interface to the display for user interaction. The user inputs appropriate spatial geometry and attribute data 705 of type specific to the form input options. Once the user clicks a button to submit this input form data, the client application captures the data, builds a response message, serializes this to JSON and sends it back to the server using HTTP over TCP/IP 706.

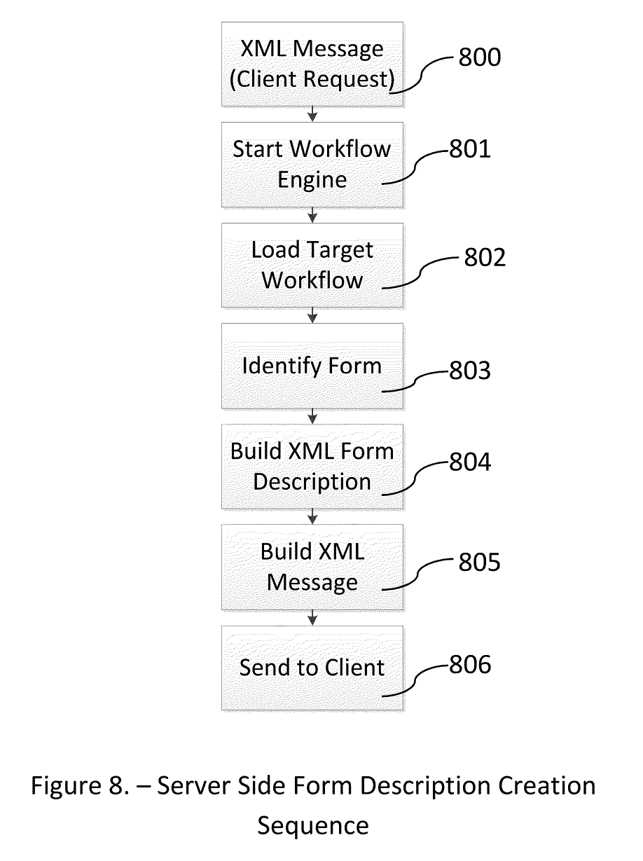

Server side workflow and spatial form creation is described in FIG. 8. Workflow initiation and launch is dependent on receiving an external client application command to begin the workflow. A unique workflow is determined by calling the appropriate webservice unique to each workflow a server may expose for discovery. The server receives a client application message 800 to start a workflow and the server initializes the workflow engine 801, passing a pointer to the eXtensible Markup Language (XML) description of the workflow to be executed, as per the webservice chosen. The workflow engine loads the target workflow 802, deciphers the workflow definition and begins executing workflow activities. When the workflow engine encounters an external, client spatial form activity 803, it builds a message 805, encloses the technology agnostic spatial workflow form definition 804, serializes to JSON and send via HTTP over TCP/IP to the client application 806.

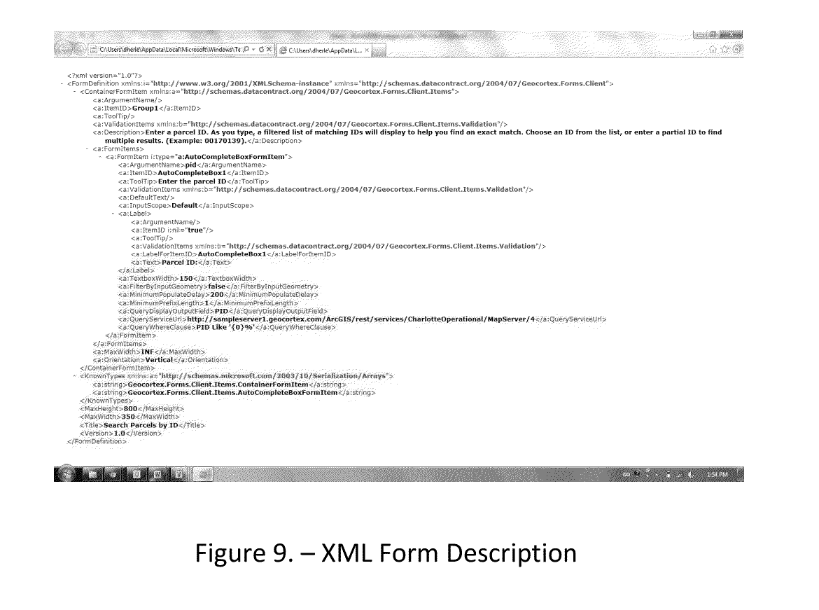

FIG. 9 shows an eXtensible Markup Language (XML) spatial form definition, stripped from a client message.

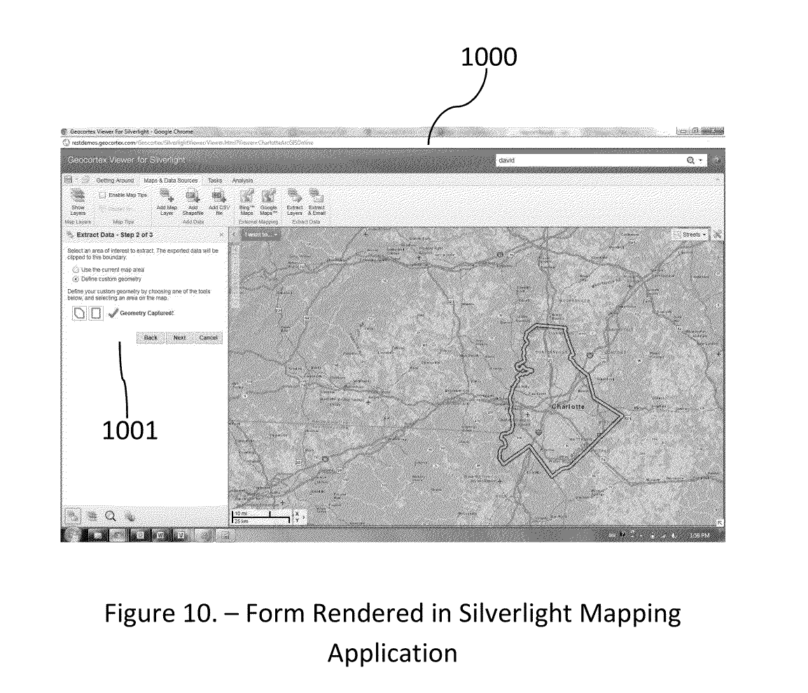

FIG. 10 shows an exemplary embodiment of a rendered, technology agnostic, spatial workflow user interface form inside a web browser based, Silverlight interactive mapping application 1000. This form 1001 is prompting the user to choose or input, via radio button, the geometry of the area to be captured as part of this workflow. The user may choose to input the current map extent or draw a custom geometry shape using the supplied polygon or rectangle shape draw tools. Once the user has captured their appropriate geometry, they are prompted to continue the workflow, return to the previous step in the workflow or cancel the workflow. Internally, the client side workflow form may receive geometry data from a variety of sources (textual input, shapes drawn on a map canvas or GPS coordinates, for example).

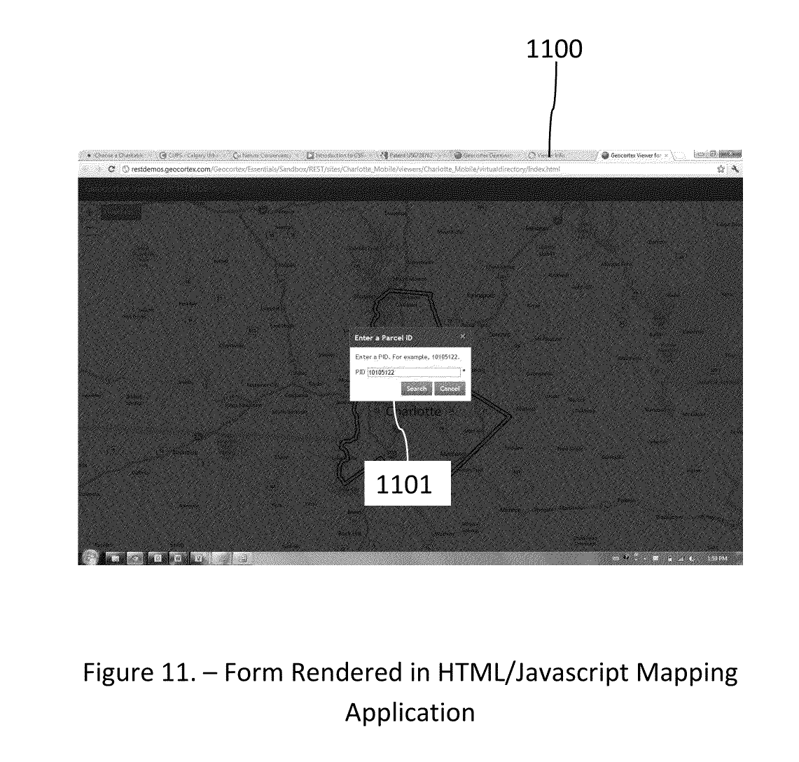

An exemplary embodiment of the invention may involve a different technology platform or client application technology for rendering and displaying spatial user interface forms as part of a workflow. FIG. 11 shows a spatial user interface form being rendered and displayed to the user inside an HTML5 based, interactive mapping application 1100. The user is being prompted to enter a Parcel ID in order to initiate a workflow search 1101. An alternative embodiment of the invention may also have the user enter a parcel ID by clicking on a parcel within the map canvas.

### ADVANTAGES OVER THE PRIOR ART

It is an advantage of the invention that a workflow designer can easily design workflow spatial data user interface forms that are client technology agnostic.

It is an advantage of the invention that a workflow designer can easily design spatial workflows that incorporate configurable user interface forms.

It is an advantage of the invention that a workflow designer can choose from a number of pre-built spatial user interface forms.

It is an advantage of the invention that a workflow designer can simulate workflow centric user interface form data collection.

It is an advantage of the invention that a workflow designer can easily export a designed workflow as a service using an administration tool.

It is an advantage of the invention that spatial workflows are webservice discoverable.

It is an advantage of the invention that workflows can be easily migrated from client platform to client platform as user needs change.

### ALTERNATIVE EMBODIMENTS

It will be appreciated that, although specific embodiments of the invention have been described here for purposes of illustration, various modifications can be made to the invention without departing from the central premise and scope of the invention.

Other embodiments of the invention may make use of different client and server hardware platforms, client and server operating systems, workflow engines, web servers, web browsers or client applications in order to implement spatial workflow form design, implementation, rendering, communication and processing.

What is claimed is:

1. A method for building client technology agnostic, service oriented workflow user interface forms for collecting spatial data input comprising:
a graphical user interface tool that permits administrators to author workflow user interface forms in a user interface technology agnostic manner in order to collect spatial data in the form of geometry and attributes;
a server-side application that exposes said workflow user interface forms via web service;
a plurality of client applications and platforms that consume and decode said service comprising said workflow user interface forms;
a plurality of client applications and operating system platforms that render said workflow user interface forms in their respective implementation technology for display to a user;
a plurality of client applications and operating system platforms that support the ability to collect geometry and attribute spatial data using a plurality of approaches to support the supplied workflow form activity.

2. The method of claim 1 further comprising a graphical user interface tool that permits a user to design a spatial workflow, comprising user interface forms to collect and process spatial data.

3. The method of claim 1 further comprising a graphical user interface tool that permits a user to select from a plurality of existing spatial workflow forms for use.

4. The method of claim 2 wherein said graphical user interface tool allows the user to chain together, in sequence, forms that comprise a spatial workflow.

5. The method of claim 2 wherein said graphical user interface tool allows the user to define workflow control flow dependencies based upon spatial geometry and attribute data gathered from said user interface forms.

6. The method of claim 2 wherein said graphical user interface tool allows the user to design a workflow interface form that includes a plurality of spatial data input options.

7. The method of claim 2 wherein the plurality of spatial data input options may not be known in advance by a client platform.

8. The method of claim 5 wherein said form includes input options that include string, text, integer, decimal, address, point, polygon, region, line, image or description to describe a spatial feature.

9. The method of claim 2 wherein said graphical user interface tool translates the visual representation of said forms and their sequence into eXtensible Markup Language (XML).

10. The method of claim 1 further comprising a server-side application that reads the eXtensible Markup Language (XML) description of the workflow user interface forms.

11. The method of claim 10 wherein said server-side application exposes the workflow forms as a webservice.

12. The method of claim 11 wherein said webservice is discoverable.

13. The method of claim 1 further comprising a plurality of client applications and operating system platforms that consume this webservice and decode the eXtensible Markup Language (XML) description of the workflow user interface forms.

14. The method of claim 10 wherein a plurality of client applications take the decoded eXtensible Markup Language (XML) description of the workflow user interface forms and dynamically renders the forms on the client user interface, using display characteristics unique to said client application and underlying operating system platform.

15. The method of claim 1 further comprising a plurality of client applications and operating system platforms that independently, and unbeknownst to any server platform or workflow controller, implement a plurality of mechanisms to locally collect geometry and attribute spatial data for provision to a plurality of spatial workflow forms.
